(19) United States
(12) Patent Application Publication
(10) Pub. No.: US 2015/0113459 A1
(43) Pub. Date: Apr. 23, 2015

(54) METHODS, SYSTEMS, APPARATUS, AND STRUCTURED LANGUAGE FOR VISUALIZING DATA

(71) Applicants: Christian Hengstler, Dresden (DE); Stefan Hesse, Dresden (DE); Martin Rosjat, Dresden (DE); Volodymyr Vasyutynskyy, Dresden (DE)

(72) Inventors: Christian Hengstler, Dresden (DE); Stefan Hesse, Dresden (DE); Martin Rosjat, Dresden (DE); Volodymyr Vasyutynskyy, Dresden (DE)

(73) Assignee: SAP AG, WALLDORF (DE)

(21) Appl. No.: 14/059,222

(22) Filed: Oct. 21, 2013

(51) Int. Cl. G06F 3/0484

(52) U.S. Cl. CPC G06F 3/0484
USPC 715/771

(57) ABSTRACT

Methods, systems, computer program products, and a structured language for defining and applying a view to a graph are described. A view comprising one or more rules, each rule comprising one or more actions for adjusting a presentation of one or more elements of a graph, may be defined. The rules may be defined using the structured language. The defined view may be applied to a selected graph.

### FIELD

The present disclosure relates generally to data analysis. In an example embodiment, the disclosure relates to a structured language and applications for visualizing graphical data.

### BACKGROUND

A graph is a well-known approach for the presentation of data, including big networks of data items and the relations between them. Graphs are well-established for the presentation of transportation routes, the presentation of knowledge in semantic networks or decision trees, and the like. With the growing number of data items to be visualized, graphs may be unmanageable and chaotic, and may confuse the user rather than support the understanding of the data. In a graph containing many elements, single elements and their relations may not be clearly represented.

To improve a user's perception of the underlying data, conventional graphs may include different types of visual support, such as the highlighting or filtering of the most relevant elements. For example, only elements having a specified attribute or color may be highlighted.

User interface controls, such as sliders and buttons, may also be provided to filter the presented elements. The user interface controls may be dedicated to single attributes of graph elements. The user may filter the elements by moving a slider, thereby, for example, setting a specific attribute value at a minimum, a maximum or a defined number. In some cases, only limited static actions like coloring or zooming may then be applied to these elements.

### BRIEF DESCRIPTION OF DRAWINGS

The present disclosure is illustrated by way of example and not limitation in the figures of the accompanying drawings, in which like references indicate similar elements and in which:

FIG. 1 illustrates an example mesh graph with a plurality of example data items;

FIGS. 2A and 2B illustrate schematic diagrams of example systems for defining and applying a view to graphical data, in accordance with an example embodiment;

FIG. 3 illustrates an example workflow of a system for defining and applying a view to graphical data, in accordance with an example embodiment;

FIG. 4 is a block diagram of an example apparatus for defining and applying a view to a visual representation of data, in accordance with an example embodiment;

FIG. 5 is a flowchart illustrating an example method for defining a view of a visual representation of data, in accordance with an example embodiment;

FIG. 6 is a representation of an example graph comprising a visual element for each node of the graph and a visual element for the connection between the nodes via edges, in accordance with an example embodiment;

FIG. 7 is a flowchart illustrating an example method for applying a view to a visual representation of data, in accordance with an example embodiment;

FIG. 8A is a representation of an example user interface for defining a view for a visual data representation, in accordance with an example embodiment;

FIG. 8B is a representation of an example user interface for applying a view to a visual data representation, in accordance with an example embodiment;

FIG. 9 is a representation of an example graph with elements and their attributes, in accordance with an example embodiment;

FIGS. 10A-10B are representations of example views applied to a graph, in accordance with an example embodiment; and

FIG. 11 is a block diagram of a computer processing system within which a set of instructions may be executed for causing the computer to perform any one or more of the methodologies discussed herein.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for visualizing data are described. In one example embodiment, a structured language for defining a view of graphical data is described.

In one example embodiment, perceptual support may be provided for visualizing graphs to enable the analysis of situations and tasks. Some tasks may be complex and may change over time. For example, data related to excessive inventory in a factory may be visualized to assist in determining a cause of the overstocking.

A manual setting of the attributes or a simple filtering by a single attribute of the graph elements may entail excessive configuration effort each time an analysis task changes. Moreover, if only single actions based on value changes of attributes of an element are configured, then only basic analysis tasks may be realized. A realistic analysis task may depend on the configuration of multiple single actions as well as efficient switching between different views of the underlying data, especially in the case of more complex analysis tasks.

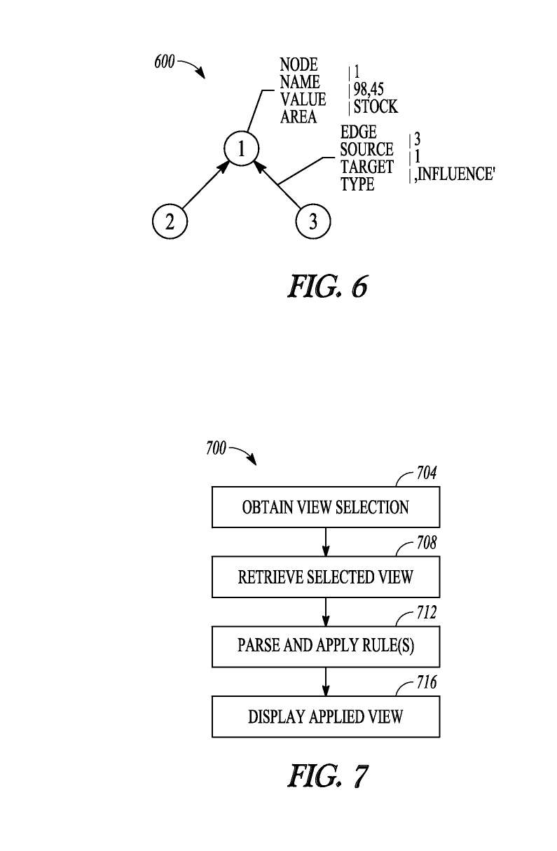

In one example embodiment, a method may provide for a formalized, extensible description of a graph representation. The formalized, extensible description of a graphical representation may be in the form of a view definition and may be tailored to an analysis of a task, problem, scenario, and the like. As used herein, a “view” may refer to a definition of a view or to an application of a view definition to data. A view may comprise a set of rules which may be based on an underlying graph model, described more fully below in conjunction with FIG. 6. Rules for adjusting the graphical presentation may be defined and stored in a view definition, and may be stored, for example, in a rules database for re-use in other views. For example, rules may be re-used in other views that are defined for analyzing other tasks, scenarios, problems, and the like, or in other views that are defined for the analysis of the same task. More complex rules may be quickly defined using the disclosed structured languages.

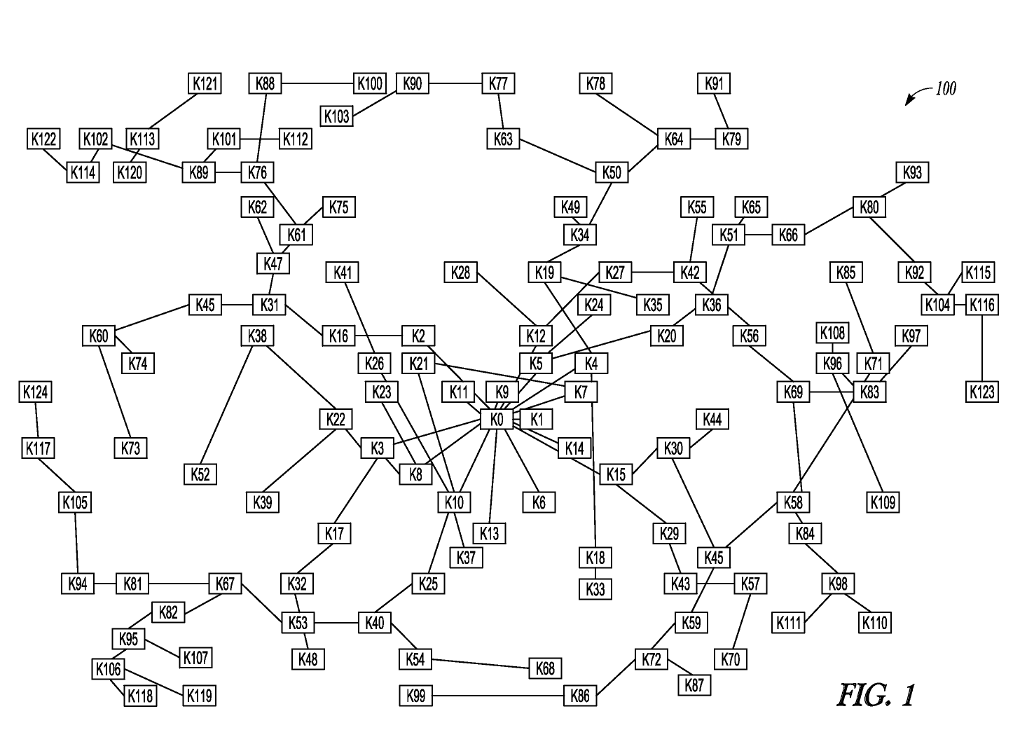

FIG. 1 illustrates an example mesh graph 100 with a plurality of example data items. As described more fully above, in a graph containing many elements, single elements and their relations may not be clearly represented, as depicted in FIG. 1.

The methods disclosed herein may be used to enhance the visibility of data items which may be related to a given analysis task, such as those of FIG. 1. This may be accomplished by defining a set of one or more views. Each view may be dedicated to a specified analysis task, or may be applicable to a number of analysis tasks. With this prerequisite, the user may focus on, for example, solving occurring problems and, in one example embodiment, viewing only task-related data items. With this enhanced visibility, the graph may be more structured and the number of displayed data items may be lower, which may improve the effectiveness of the analysis.

In one example embodiment, a rule may comprise one or more dedicated actions for adjusting the presentation of the graph element(s). Actions may be executed on a subset of the data elements or all of the data elements. In one example embodiment, a change of the view of the data may correspond to a change in the visual presentation of the graph while the definition of the graph remains unchanged. For example, the appearance of the graph may be adjusted for a given analysis task according to a corresponding view, while the nodes and the structure of the graph remain unchanged.

The analysis tasks may be defined by one or more rules that may trigger one or more actions when a corresponding rule condition is satisfied. The rule condition may require, for example, that an attribute value of a node of the graph is within a defined range. One or more actions may be triggered when the value of the attribute is within the defined range. There is no requirement to directly set the properties or attributes of the graph elements. The rules may be stored under a corresponding view.

In one example embodiment, a user uses knowledge and/or experience to formulate rules for a view that addresses a particular analysis task, or set of tasks. The rules can be exchanged and reused to address the analysis of other tasks. In one example embodiment, the description of analysis tasks may be independent of the realization of various graph tools. In one example embodiment, the rules may add a layer of abstraction to the graphs, and the logical and visual representations of a graph may be separated. Rules and/or views may be reused for similar graphs and/or similar analysis tasks.

Furthermore, a single defined view may allow directing the user's focus on the graph element(s) and the associated data which may be most relevant to the analysis task(s). By defining a plurality of different views, an analysis of a variety of tasks may be performed, and a user may easily switch from one view and associated task to another view of the same task, or to a view of another task.

Many scenarios may benefit from the disclosed perceptual tools in comparison to simple visual support like highlighting, filtering, zooming, and the like. These scenarios may benefit from the utilization and combination of different graphical elements and their attributes. The graphical elements and their attributes may be applicable in a range of analysis tasks. The tasks may address different problems or situations. An example of such a task is a quick detection of problem(s) in a production plant and the identification of possible causes of the problem(s). The results of such an analysis may be needed within a certain period of time. For example, an analysis may need to be performed to determine a cause of excess inventory in a factory or warehouse.

### Multi-Tiered Enterprise Computing Systems

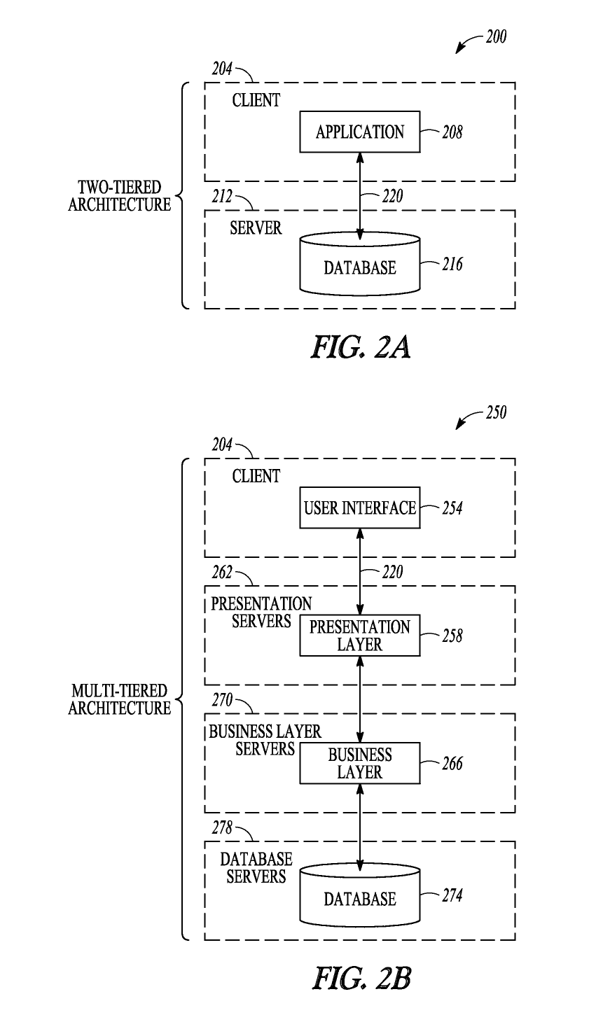

FIGS. 2A and 2B illustrate schematic diagrams of example systems 200, 250 for defining and applying a view to graphical data, in accordance with an example embodiment. Traditional client-server systems may employ a two-tiered architecture such as that illustrated by system 200 in FIG. 2A. Application 208 executed on the client 204 of the two-tiered architecture may be comprised of a monolithic set of program code including a graphical user interface component, presentation logic, business logic and a network interface that enables the client 204 to communicate over a network 220 with one or more servers 212. Each server 212 may also communicate with a plurality of clients. A database 216 may be maintained on the server 212 that provides non-volatile or “persistent” storage for the data accessed and/or processed by the application 208.

The “business logic” component of the application 208 may represent the core program code of the application 208, i.e., the rules governing the underlying business process (or other functionality) provided by the application 208. The “presentation logic” may describe the specific manner in which the results of the business logic are formatted for display on the user interface. The “database” 216 may include data access logic used by the business logic to store and retrieve data.

In response to limitations associated with the two-tiered client-server architecture, a multi-tiered architecture has been developed, as illustrated in FIG. 2B. In the multi-tiered system 250, the presentation layer 258, business layer 266 and database 274 may be logically separated from the user interface 254 of the application. These layers may be moved off of the client 204 to one or more dedicated servers on the network 220. For example, the presentation layer 258, the business layer 266, and the database 274 may each be maintained on separate servers.

This separation of logical components and the user interface 254 may provide a more flexible and scalable architecture compared to that provided by the two-tiered model. For example, the separation may ensure that all clients 204 share a single implementation of business layer 266. If business rules change, changing the current implementation of business layer 266 to a new version may not call for updating any client-side program code. In addition, the presentation layer 258 may be provided, which generates code for a variety of different user interfaces 254, which may be standard browsers.

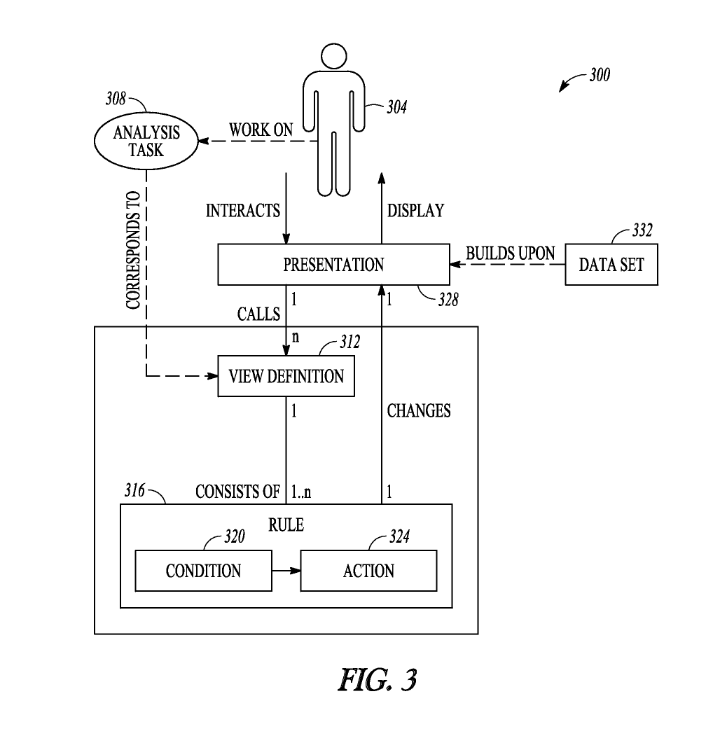

FIG. 3 illustrates an example workflow 300 of a system for defining and applying a view to graphical data, in accordance with an example embodiment. A user 304 may work on an analysis task 308 using a data set 332. For example, an inventory of a particular item in a warehouse or factory may be excessively large and the user 304 may define an analysis task 308 to determine the cause of the excess inventory. The user 304 may define a view definition 312 via a presentation layer 328 to assist in analyzing the task. For example, the user 304 may define a set of rules 316 based on user knowledge and experience. Each rule 316 may comprise a condition 320 and an action 324, as described more fully below. The user 304 may define multiple views prior to and/or during the performance of the analysis task 308. The user 304 may access previously defined rules and/or previously defined views during the analysis task 308 that were created by the user 304 or by another user.

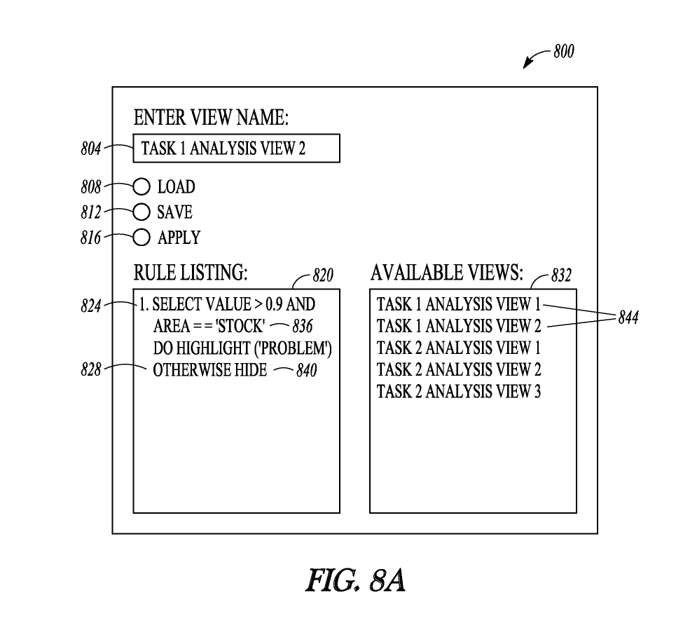

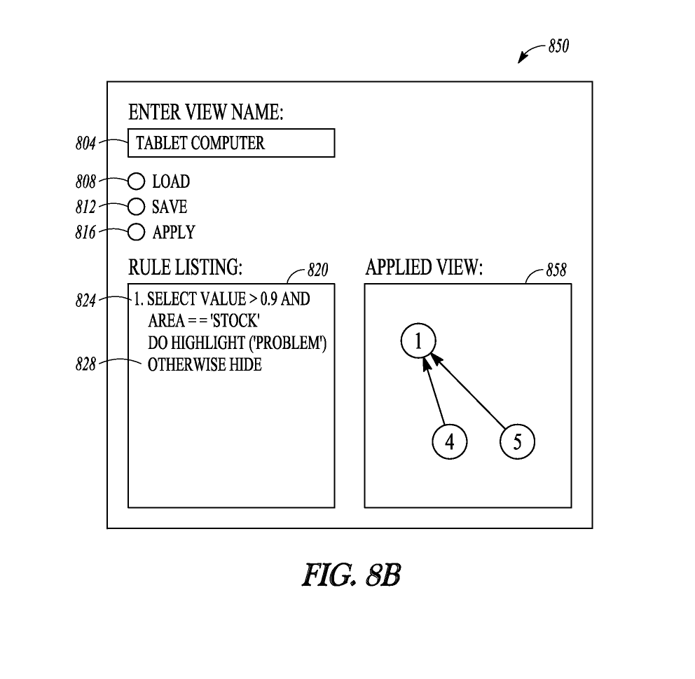

The user 304 may interact with a presentation layer 328 that may display a view definition and may display a rendered view of the graphical data based on the data set 332. For example, the presentation layer 328 may utilize the user interface of FIGS. 8A and 8B, described below, to interact with the user 304.

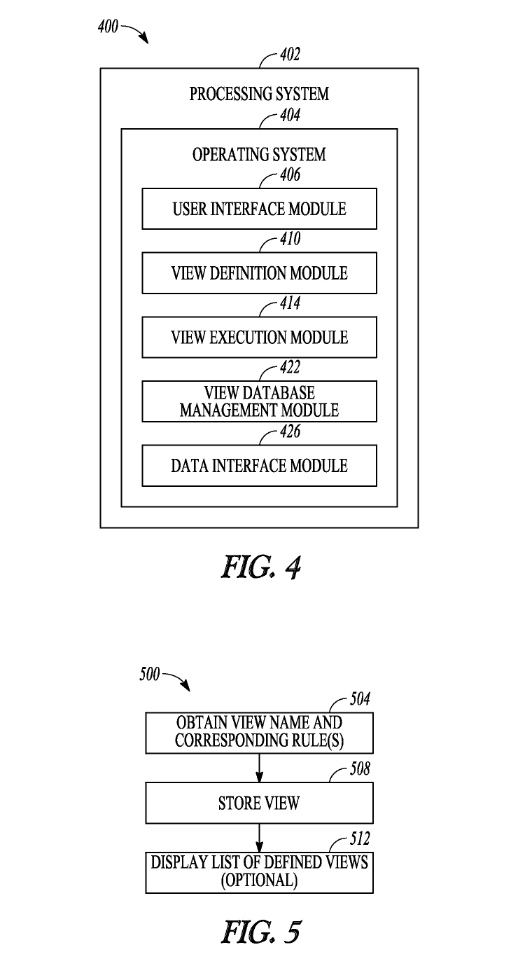

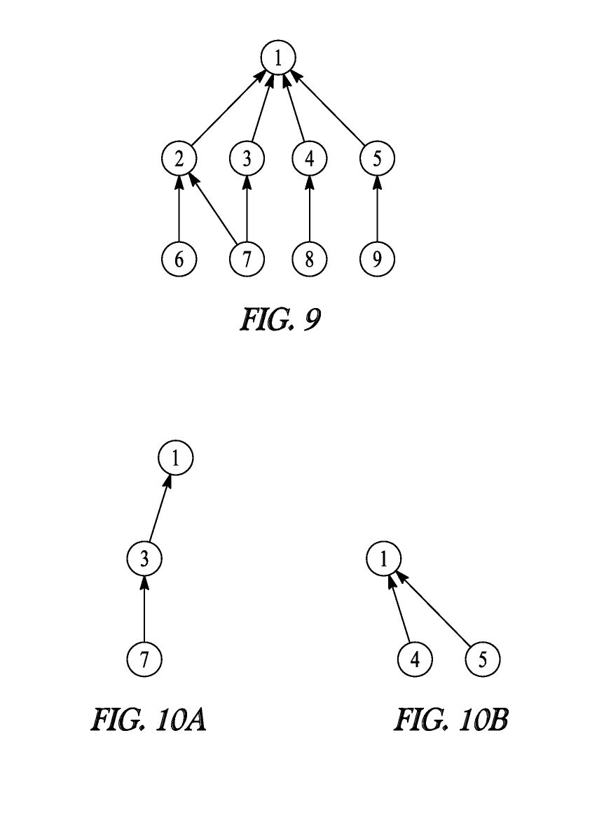

FIG. 4 is a block diagram of an example apparatus 400 for defining and applying a view to a visual representation of data, in accordance with an example embodiment. For example, the apparatus 400 may be used to execute a view on the graph of FIG. 9 (described below).

The apparatus 400 is shown to include a processing system 402 that may be implemented on a server, client, or other processing device that includes an operating system 404 for executing software instructions. In accordance with an example embodiment, the apparatus 400 includes a user interface module 406, a view definition module 410, a view execution module 414, and a view database management module 422. In accordance with an example embodiment, the apparatus 400 may include a data interface module 426.

The user interface module 406 may generate a user interface for defining rules; for defining, storing, managing, and retrieving views; and for applying, rendering, and displaying views of graphical data. For example, the user interface module 406 may generate a user interface 800 and/or 850, as described more fully below in conjunction with of FIGS. 8A and 8B, respectively.

The view definition module 410 may obtain rules associated with a view and may store the view and associated rules for future use, as described more fully in conjunction with FIG. 5.

The view execution module 414 may apply one or more rules associated with a view to render a visual representation of a graph defined for a particular analysis task, as described more fully in conjunction with FIG. 7.

The view database management module 422 may manage the storage of defined views and rules. For example, the view database management module 422 may provide a list of available views for a user and may retrieve a defined view from a storage unit for application to a graph, as described more fully below in conjunction with FIGS. 8A and 8B. The view database management module 422 may also access and retrieve rules to assist in the definition of new views.

The data interface module 426 may provide access to graphical data to be rendered in a view generated by the view execution module 414. For example, the data interface module 426 may access database 216.

FIG. 5 is a flowchart illustrating an example method 500 for defining a view for a visual representation of data, in accordance with an example embodiment.

A name of a view and one or more rules associated with the view may be obtained (operation 504). For example, a user may name a view in a view entry field 804 and may define one or more rules in a rule definition area 820, as described more fully below in conjunction with FIGS. 8A and 8B. In one example embodiment, the user may select one or more rules from a rules database and add the selected rules to a view definition. The selected rules may be modified to tailor them to a particular task. The view may be stored, for example, in database 216 (operation 508). A list of defined views may optionally be displayed (operation 512). For example, a list of available views 844 may be displayed in view display field 832, as described more fully below in conjunction with FIG. 8A.

In one example embodiment, the visibility of data elements, such as nodes, edges, and the like, that may correspond to items important to the analysis of the situation, may be enhanced. The items may be associated with the problem(s) related to the situation. In one example embodiment, factors influencing the items may be defined by the user and may include the causes of the problem(s) associated with the situation.

In one example embodiment, less relevant elements may be hidden or de-emphasized. The hiding or de-emphasis of less relevant items may enable a user to focus on the more relevant elements. A new view, or extract, based on the same underlying graph for a particular analysis task may be created.

A view may be defined by one or more rules; the view may correspond to a specific analysis task utilizing the graph, as described more fully above. A variety of conditions and actions may be clustered in one or more rules.

In one example embodiment, the grammar for a rule definition may be in Backus-Naur form. For example, a rule may be structured as follows:

<View>::=[<Rule>]1 . . . n<Rule>::=<Condition>[<Relation><Condition>]*==>[<Action>]1 . . . n where:

<View> is defined by a set of one or more rules;

<Rule> is a tuple consisting of one or more conditions and one or more actions;

<Condition> is the definition of a condition of the elements in the form of a triple: <Attribute><Relation><Value>;

<Relation> is a logical relation; and

<Action> describes the action that should be applied on the elements that match the rule.

In one example embodiment, <Value> may be, for example, value >0,9. A logical relation may be, for example, AND, OR, and the like.

In one example embodiment, an action is defined as <Action>([<Parameter>]*). Multiple actions may be defined to execute in parallel or sequentially. Each action may be applied to a single element or may be applied to a plurality of elements.

Actions may include, for example:

1) COLOR (‘red’|‘green’ . . . )—setting the color of the element;

2) HIDE—the element is made hidden;

3) SHOW—the element is shown;

4) HIGHLIGHT (‘Problem’|‘Cause’ . . . )—highlight the element according to the settings;

5) SET <Attribute>=Value—set the view-related attribute(s);

6) FOCUS—set the focus to a selected element; and

7) LAYOUT(<LayoutName>)—apply a certain layout.

The “highlight” action may utilize a visual effect(s) to highlight an element. Different types of highlighting actions, or a combination of highlighting actions, may be used. For example, an element may be displayed in a particular color, may be displayed with a shadow effect, may be displayed with a bold font (applicable to text associated with the element), and the like.

In one example embodiment, a “problem-cause” highlighting of one or more nodes may be applied. For example, a simple sub-tree of a graph may contain one root node and three leaf nodes; the three leaf nodes may influence the root node. The root cause (i.e., the cause of the problem that is the subject of the analysis task) may be highlighted with the color red.

Another highlighting rule may calculate a correlation coefficient associated with each of the leaf nodes using the historical data of the values of the three leaf nodes. The leaf node having the highest correlation coefficient may be highlighted as the most probable cause of the problem, e.g. highlighted with the color orange. The leaf node with the second-highest correlation coefficient may be highlighted as the second-probable cause, e.g. highlighted with the color yellow.

The “focus” action may enable an element, such as a node or edge, to be made the focus of a user's attention. The element to be focused on may be selected according to a rule. For example, a rule may define the most critical element (e.g., the key performance indicator (KPI) with the most critical status) as an element to be focused on. The element which is selected may be displayed in a particular color, displayed with a shadow effect, displayed in the center of the screen, and the like.

The “layout” action may apply, for example, a special layout algorithm on the elements and may set the layout in accordance with a rule. Depending on the application of the graph, a particular layout may be more convenient for the user to view. For example, for hierarchical KPI's, a tree-based representation may be used with higher-level and lower-level KPI's. For transportation networks, the graphs may be mapped to the layout of the transportation routes. The layout action may be applied on the whole graph or only on a subset(s) of the graph, and rules defining the layout may be applied on the whole graph or only on a subset(s) of the graph. In one example embodiment, a graph may combine different layouts (e.g., tree-based and circle-based) to optimally represent the graph to the user.

The following is an example of a rule, in accordance with an example embodiment:

rule1::=value>0,9 AND area==‘stock’==>HIGHLIGHT(‘problem’)

In one example embodiment, a rule may be defined for one specific element and may contain an identification of the specified element. In one example embodiment, a syntax similar to SQL may be utilized to enhance a reading of the rule by a user. For example, rule 1 may be formulated as follows:

SELECT value>0.9 AND area==‘stock’ DO HIGHLIGHT(‘problem’) OTHERWISE HIDE.

In one example embodiment, a pre-assumption for the definition of rules may be that the model of a graph includes the following elements:

1) nodes comprising an array of attributes such as key-value pairs; and

2) edges comprising an array of attributes such as key-value pairs.

An example of an attribute of a node is ID (identification), name, value, value unit, description, state, area, logic, and the like. An example of an edge is ID (identification), name, description, source, target, type, and the like.

FIG. 6 is a representation of an example graph comprising a visual element for each node of the graph and a visual element for the connection between the nodes via edges (such as lines or paths), in accordance with an example embodiment. In one example embodiment, it may be important that the attributes of the elements have a similar semantic structure and meaning within the graph. A typical graph may be visualized by a visual element(s) for each node and by a visual element(s) for the connection(s) between the nodes via edges (such as lines or paths).

FIG. 7 is a flowchart illustrating an example method 700 for applying a view to a visual representation of data, in accordance with an example embodiment.

In one example embodiment, a selection of a view may be obtained from, for example, a user via the user interface module 406 (operation 704). For example, a user may select a view from view display field 832, as described more fully below in conjunction with FIG. 8A. The selected view may be retrieved from, for example, database 216 (operation 708). Each rule of the retrieved view may be parsed and applied to the rendered view of the graphical data (operation 712). The rendered view may be displayed in applied view display area 858, as described more fully in conjunction with FIG. 8B (operation 716).

FIG. 8A is a representation of an example user interface 800 for defining a view for a visual data representation, in accordance with an example embodiment.

A user may define one or more rules in a rule definition area 820. The rules may be identified by a rule number 824. Each rule 828 may comprise a tuple comprising one or more conditions 836 and one or more actions 840, as described more fully above. The view may be named in view entry field 804 and may be stored with its corresponding rules in, for example, database 216 by selecting the view save radio button 812. A saved view may be retrieved by entering the view name in the view entry field 804 and selecting a user interface control element, such as the view load radio button 808.

A loaded view may be applied by selecting a user interface control element, such as the view apply radio button 816. In one example embodiment, the view may automatically be applied once a loading of the view is complete. In one example embodiment, a list of available views 844 may be displayed in view display field 832. A user may switch from one view to another view by simply selecting the name of the desired view.

FIG. 8B is a representation of an example user interface 850 for applying a view to a graph, in accordance with an example embodiment. In response to applying a view, the applied view may be displayed in applied view display area 858.

### Example View Definition

FIG. 9 is a representation of an example initial complete graph with elements and their attributes, in accordance with an example embodiment. In one example, a task may be defined for indicating possible causes of excess inventory in a factory. The view may be defined as:

View1(‘Diagnosis of stock problems’):=rule1 AND rule2

rule1::=value>0,9 AND area==‘stock’==>HIGHLIGHT(‘problem’)

rule2::=state‘high’ OR state==‘medium’ AND area==‘stock’==>HIGHLIGHT(‘cause’) OTHERWISE HIDE

FIGS. 10A and 10B are representations of applying example views to the graph of FIG. 9, in accordance with an example embodiment. FIG. 10A illustrates the result of applying view 1 to the graph of FIG. 9 and FIG. lOB illustrates the result of applying view 2 to the graph of FIG. 9. FIGS. 10A and lOB demonstrate that the application of the rules on the data set 332 of two different days produces different results since the underlying data changed. In the cited examples, this means that, on day one (FIG. 10A), the problem of element 1 is caused by the influence of element 7 and, on day two (FIG. 10B), the problem of element 1 is caused by the influence of elements 4 and 5. In FIGS. 10A and 10B, the less relevant elements have been hidden.

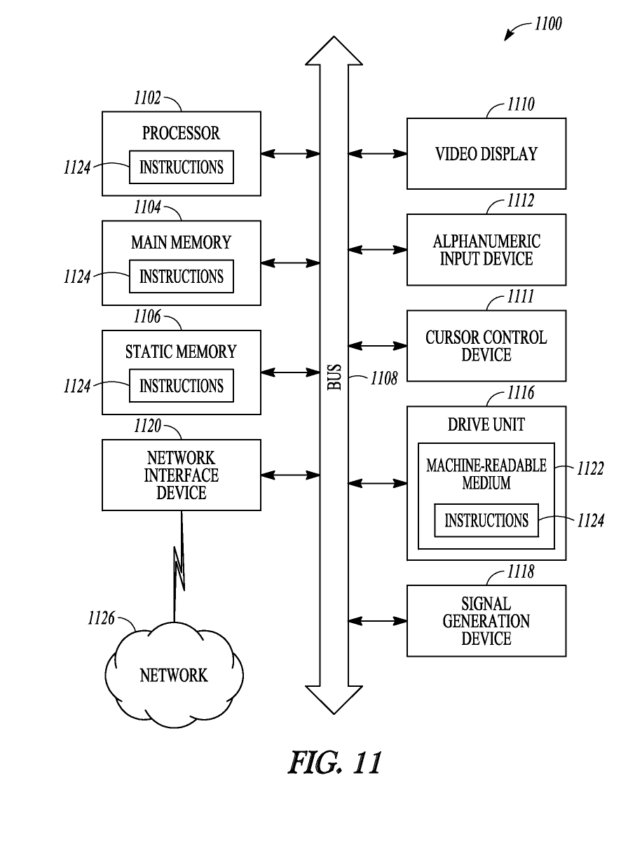

FIG. 11 is a block diagram of a computer processing system 1100 within which a set of instructions 1124 may be executed for causing the computer to perform any one or more of the methodologies discussed herein. In some embodiments, the computer operates as a standalone device or may be connected (e.g., networked) to other computers. In a networked deployment, the computer may operate in the capacity of a server or a client computer in a server-client network environment, or as a peer computer in a peer-to-peer (or distributed) network environment.

Embodiments may also, for example, be deployed by Software-as-a-Service (SaaS), Application Service Provider (ASP), or utility computing providers, in addition to being sold or licensed via traditional channels. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 1100 includes processor 1102 (e.g., a central processing unit (CPU), a graphics processing unit (GPU) or both), main memory 1104 and static memory 1106, which communicate with each other via bus 1108. The processing system 1100 may further include video display unit 1110 (e.g., a plasma display, a liquid crystal display (LCD) or a cathode ray tube (CRT)). The processing system 1100 also includes alphanumeric input device 1112 (e.g., a keyboard), a cursor control device 1111 (e.g., a mouse, touch screen, or the like), a disk drive unit 1116, a signal generation device 1118 (e.g., a speaker), and a network interface device 1120.

The disk drive unit 1116 includes computer-readable medium 1122 on which is stored one or more sets of instructions 1124 and data structures (e.g., software) embodying or utilized by any one or more of the methodologies or functions described herein. The instructions 1124 may also reside, completely or at least partially, within the main memory 1104, static memory 1106, and/or within the processor 1102 during execution thereof by the processing system 1100, the main memory 1104, static memory 1106, and the processor 1102 also constituting computer-readable, tangible media.

The instructions 1124 may further be transmitted or received over network 1126 via a network interface device 1120 utilizing any one of a number of well-known transfer protocols (e.g., Hypertext Transfer Protocol).

While the computer-readable medium 1122 is shown in an example embodiment to be a single medium, the term “computer-readable medium” should be taken to include a single medium or multiple media (e.g., a centralized or distributed database, and/or associated caches and servers) that store the one or more sets of instructions 1124. The term “computer-readable medium” shall also be taken to include any medium that is capable of storing, encoding or carrying a set of instructions 1124 for execution by the computer and that cause the computer to perform any one or more of the methodologies of the present application, or that is capable of storing, encoding or carrying data structures utilized by or associated with such a set of instructions 1124. The term “computer-readable medium” shall accordingly be taken to include, but not be limited to, solid-state memories, and optical and magnetic media.

While the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for providing a service, the method comprising:
defining a view comprising one or more rules, each rule comprising one or more actions for adjusting a presentation of one or more elements of a graph;
storing the view for application to one or more graphs; and
applying the view to at least one of the one or more graphs.

2. The method of claim 1, wherein one or more of the one or more rules may be stored for use in another view.

3. The method of claim 1, wherein a structure of the graph remains unchanged by the application of the view.

4. The method of claim 1, wherein the view is reused to analyze a plurality of tasks.

5. The method of claim 1, wherein the view enables a task analysis using a configuration of multiple single actions.

6. The method of claim 1, further comprising:
selecting one or more stored rules;
modifying one or more of the selected rules; and
adding one or more of the selected rules and the modified rules to the view.

7. The method of claim 1, wherein the view is defined by a structured language for defining the one or more rules, each rule is structured as:
<View>::=[<Rule>]1 . . . n <Rule>::=<Condition>[<Relation><Condition>]*==>[<Action>]1 . . . n.

8. The method of claim 1, wherein a selection of a view automatically applies the selected view.

9. An apparatus for providing a service, the apparatus comprising:
a processor;
memory to store instructions that, when executed by the processor cause the processor to:
define a view comprising one or more rules, each rule comprising one or more actions for adjusting a presentation of one or more elements of a graph;
store the view for application to one or more graphs; and
apply the view to at least one of the one or more graphs.

10. The apparatus of claim 9, wherein one or more of the one or more rules may be stored for use in another view.

11. The apparatus of claim 9, wherein a structure of the graph remains unchanged by the application of the view.

12. The apparatus of claim 9, wherein the view is reused to analyze a plurality of tasks.

13. The apparatus of claim 9, wherein the view enables a task analysis using a configuration of multiple single actions.

14. The apparatus of claim 9, further comprising instructions that, when executed by the processor cause the processor to:
select one or more stored rules;
modify one or more of the selected rules; and
add one or more of the selected rules and the modified rules to the view.

15. The apparatus of claim 9, wherein the view is defined by a structured language for defining the one or more rules, each rule is structured as:
<View>::=[<Rule>]1 . . . n<Rule>::=<Condition>[<Relation><Condition>]*==>[<Action>]1 . . . n.

16. The apparatus of claim 9, wherein a selection of a view automatically applies the selected view.

17. A non-transitory machine-readable storage medium comprising instructions that, when executed by one or more processors of a machine, cause the machine to perform operations comprising:
defining a view comprising one or more rules, each rule comprising one or more actions for adjusting a presentation of one or more elements of a graph;
storing the view for application to one or more graphs; and
applying the view to at least one of the one or more graphs.

18. The non-transitory machine-readable storage medium of claim 17, wherein one or more of the one or more rules may be stored for use in another view.

19. The non-transitory machine-readable storage medium of claim 17, wherein a structure of the graph remains unchanged by the application of the view.

20. The non-transitory machine-readable storage medium of claim 17, further comprising:
selecting one or more stored rules;
modifying one or more of the selected rules; and
adding one or more of the selected rules and the modified rules to the view.
